(19) United States
(12) Patent Application Publication
(10) Pub. No.: US 2019/0246573 A1
(43) Pub. Date: Aug. 15, 2019

(54) Greenhouse with Integrated Irrigation and Environmental Control Systems

(71) Applicant: Fidel M. Ruiz, Paramount, CA (US)

(72) Inventor: Fidel M. Ruiz, Paramount, CA (US)

(21) Appl. No.: 16/273,844

(22) Filed: Feb. 12, 2019

Related U.S. Application Data
(60) Provisional application No. 62/629,211, filed on Feb. 12, 2018.

(51) Int. Cl. A01G 9/26; A01G 9/24; A01G 13/02

(52) U.S. Cl. CPC A01G 9/26; A01G 9/242; A01G 2009/1446; A01G 9/247; A01G 13/0206; A01G 9/246

(57) ABSTRACT

A greenhouse with integrated irrigation and environmental control system includes a main structure, an irrigation system, an environmental control system, a control module, and a protective sheet of netting. The main structure is enclosed by the protective sheet of netting. Further, the irrigation system and the environmental control system are mounted within the main structure. The environmental control system regulates the humidity in the main structure, as well as provides surveillance of the main structure. As such, the environmental control system includes a camera, a motion sensor, a humidity sensor, and a plurality of fans. The irrigation system provides plants and vegetation with the necessary hydration and nutrients. As such, the irrigation system includes a tubular sprinkler, an irrigation line, a plurality of storage tanks, and a pump.

The current application claims a priority to the U.S. Provisional Patent application Ser. No. 62/629,211 filed on Feb. 12, 2018.

### FIELD OF THE INVENTION

The present invention generally relates to a greenhouse featuring a canopy made of protective netting for keeping insects and debris out of the greenhouse while letting sunlight and fresh air in. Further, the present invention utilizes an integrated irrigation and environmental control systems that can be remotely operated via wireless communication network.

### BACKGROUND OF THE INVENTION

Around the world, greenhouses are used for growing plants and vegetation in a temperature and humidity-controlled environment all throughout the year. Greenhouses range in size, from small residential greenhouses for personal use to large agricultural greenhouses that can span several acres. Generally, greenhouses use glass to trap and retain heat even in cold climates. They are usually sealed off to prevent disruptions to the controlled climate inside. However, this results in poor ventilation and allows bacteria and pathogens to thrive in the still air environment. These bacteria produce mold and can be harmful to the vegetation inside the greenhouse.

Plants generally need three essential substances to survive: food, water, and sunlight. Within a greenhouse, sunlight can be provided abundantly and passively through the glass windows. However, food and water must be provided manually. A user must regularly enter the greenhouse to water the plants or to spread fertilizer, which often ends up compromising the controlled environment of the greenhouse. It also provides access for animals or insects to enter and destroy the vegetation.

An objective of the present invention is to provide a means for tending to the vegetation inside the greenhouse without compromising the integrity of the controlled climate. To accomplish this, the invention features an integrated irrigation system. This system allows for water and nutrients to be supplied to the vegetation without need of the user entering the main structure. Phosphorous, nitrogen, and potassium are held in tanks outside the main structure and a water supply is connected via a hose fixture. Irrigation lines provide a path for these substances to be transferred into the main structure to be spread throughout the vegetation. A control panel displays the levels of each substance that is being provided to the tank. A pump allows the user to control the flow of each substance. This ensures that the climate is kept optimal and no animals or insects have an opportunity to enter the structure. However, a door is provided for the user to enter the main structure at will for various reasons, including but not limited to harvesting. Finally, the present invention also makes pesticides obsolete by sealing off the outside environments and preventing insects from entering the greenhouse.

To solve the problem of a lack of circulation, a water-proof fan is fitted onto the main structure. The fan includes a humidity sensor that controls the speed of the fan. This allows air to be circulated within the main structure. In addition to the fan, the main structure canopy is made of netting. This cross-weaved netting has small holes to allow for fresh air to enter the main structure. The netting also provides a protective barrier against unwanted animals or insects, including butterflies, caterpillars, moths, dogs, cats, possums, rats, racoons, birds, rabbits, and the like. A waterproof camera is attached to the main structure to provide a view inside. The camera sends video via a wireless communication module on the control panel. Since the control panel features wireless communication module, a cellular device can be connected to access various real-time data information generated by the control panel. Finally, a motion sensor inside the main structure is also provided for added security.

### SUMMARY OF THE INVENTION

The invention is a novel greenhouse which features a canopy made of protective netting for keeping insects and debris out of the greenhouse while letting sunlight and fresh air in. The invention features various additional components such as, but not limited to, an integrated irrigation system, a control panel, wireless communication module, a camera, and a plurality of fans. As such, the present invention is designed to address the issue inadequate air ventilation and trespassing of unwanted animals or insects within the greenhouse.

### BRIEF DESCRIPTION OF THE DRAWINGS

FIG. 1 is a front and top perspective view of the present invention.

FIG. 2 is a front and top perspective exploded view of the present invention.

FIG. 3 is a rear and top perspective view of the irrigation system.

FIG. 4 is a front perspective exploded view of the main structure.

FIG. 5 is a detail view of section 4 in FIG. 3 illustrating the connection between the plurality of crossbeams and the plurality of corner columns.

FIG. 6 is a detail front perspective view illustrating the connection between the door mount, the entrance aperture, and the door.

FIG. 7 a front plan view of the present invention illustrating the plurality of nutrient tanks connected to the mixture tank.

FIG. 8 is a schematic drawing illustrating the electric connection between the power source, the wireless communication module, and the control panel.

FIG. 9 is a front and top perspective view of the control panel and the power source mounted adjacent to the main structure.

FIG. 10 is a front top perspective view of the main structure with the hallway attached to the main structure.

### DETAILED DESCRIPTION OF THE INVENTION

All illustrations of the drawings are for the purpose of describing selected versions of the present invention and are not intended to limit the scope of the present invention.

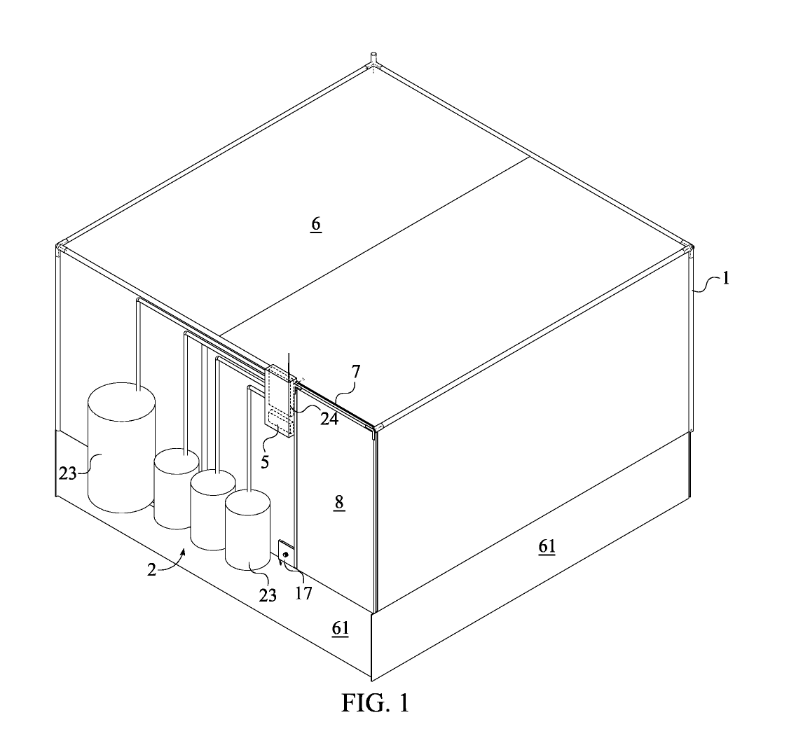

The present invention is a greenhouse with integrated irrigation and environmental control systems enclosed within a mesh netting to provide ventilation. Referring to FIG. 1, the preferred embodiment of the present invention comprises a main structure 1, an irrigation system 2, an environmental control system 4, a control module 5, a protective sheet of netting 6, and a sealing sheet of netting 61. The main structure 1 encloses a temperature-controlled, humidity-controlled environment for growing plants and vegetation. The preferred main structure 1 has a tubular space frame design to reduce the weight and increase the structural integrity.

The main structure 1 is enclosed by the protective sheet of netting 6. Preferably, the protective sheet of netting 6 is designed to prevent insects and air-borne contaminants from entering the main structure 1 while providing sufficient ventilation. The preferred protective sheet of netting 6 is transparent to allow sunlight for the plants and vegetation to enter the main structure 1. Further, the sealing sheet of netting 61 is mounted around the border of the main structure 1. The sealing sheet of netting 61 seals the borders of the main structure 1 and prevents insects and rodents from burrowing under the main structure 1. The irrigation system 2 and the environmental control system 4 are mounted within the main structure 1. The irrigation system 2 is mounted over the plants and sprinkles a nutrient mixture customized to specific plants. The temperature, humidity, and ventilation in the main structure 1 is controlled by the environmental control system 4. A user can control each of these environmental factors via the control module 5 which is electrically connected to the environmental control system 4.

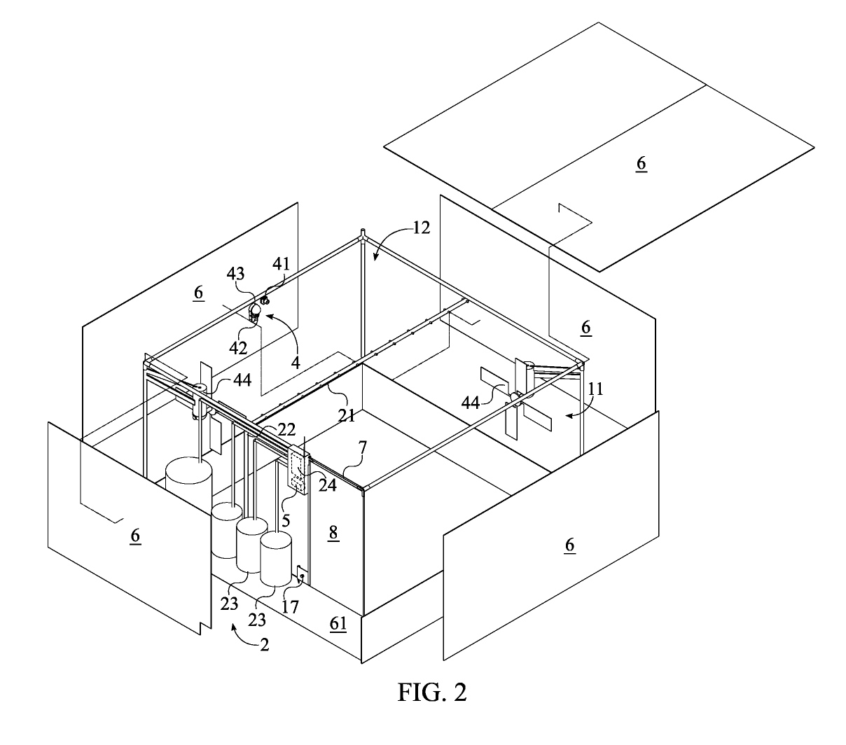

Referring to FIG. 2, in the preferred embodiment, the environmental control system 4 comprises a camera 41, a motion sensor 42, a humidity sensor 43, and a plurality of fans 44. The camera 41 and the motion sensor 42 provide 24-hour surveillance of the interior and exterior of the main structure 1. To control the moisture inside the main structure 1, the humidity sensor 43 activates plurality of fans 44 to circulate air through the protective sheet of netting 6. Each of the plurality of fans 44 is connected adjacent to a lateral side 11 of the main structure 1 to ensure sufficient airflow. Similarly, the camera 41 and the motion sensor 42 are mounted adjacent to a ceiling 12 of the main structure 1. This gives the camera 41 a 360-degree view of the interior and minimizes any blind spots. Similarly, the motion sensor 42 can also detect motion anywhere inside the main structure 1. Finally, the pump 24, the humidity sensor 43, the camera 41, the motion sensor 42, and the plurality of fans 44 are electrically connected to the control module 5. In the preferred embodiment, the control module 5 is a computer with wireless capabilities that may be controlled remotely or directly by someone inside the main structure 1. Using the control module 5, the user can control the camera 41 and the motion sensor 42 to monitor what is happening inside the main structure 1 at anytime from anywhere in the world. The user can also control the humidity by activating the plurality of fans 44. Similarly, the user can activate the irrigation system 2 by actuating the pump 24 via the control module 5.

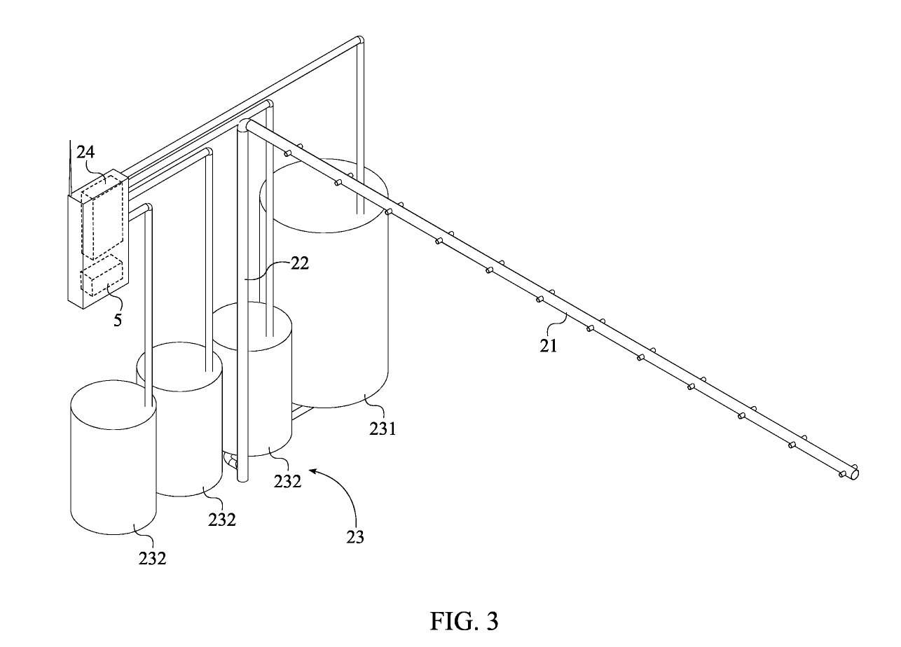

Referring to FIG. 2 and FIG. 3, the irrigation system 2 comprises a tubular sprinkler 21, an irrigation line 22, a plurality of storage tanks 23, and the pump 24. The pump 24 circulates a nutrient mixture from the plurality of storage tanks 23, through the irrigation line 22, and into the tubular sprinkler 21. To ensure the nutrient mixture is evenly dispensed within the main structure 1, the tubular sprinkler 21 is positioned across the ceiling 12 of the main structure 1. The preferred embodiment of the present invention uses a single tubular sprinkler 21 to dispense the nutrient mixture. Alternate embodiments of the present invention may utilize a plurality of tubular sprinklers 21. Each of the plurality of storage tanks 23 stores a specific nutrient that is required by the plants. The nutrient from each of plurality of the storage tanks 23 is mixed to create the nutrient mixture and dispensed through the irrigation line 22. Additionally, the tubular sprinkler 21 is in fluid communication with the plurality of storage tanks 23 via the irrigation line 22 and the pump 24. More specifically, the pump 24 is operatively coupled in between the tubular sprinkler 21 and the plurality of storage tanks 23 by the irrigation line 22. This allows the pump 24 to extract the nutrient from each of the plurality of storage tank 23.

Referring back to FIG. 2, the protective sheet of netting 6 is attached to each lateral side 11 and the ceiling 12 of the main structure 1. In the preferred embodiment, the protective sheet of netting 6 comprises a plurality of sheets. As such, each lateral side 11 of the main structure 1 is covered by a corresponding sheet from the plurality of sheets. Each sheet is attached via a plurality of fasteners distributed along the perimeter of the lateral side 11. The preferred embodiment of the plurality of fasteners may include hooks. In another possible embodiment, the protective sheet of netting 6 may be a single sheet of fabric that encloses the main structure 1.

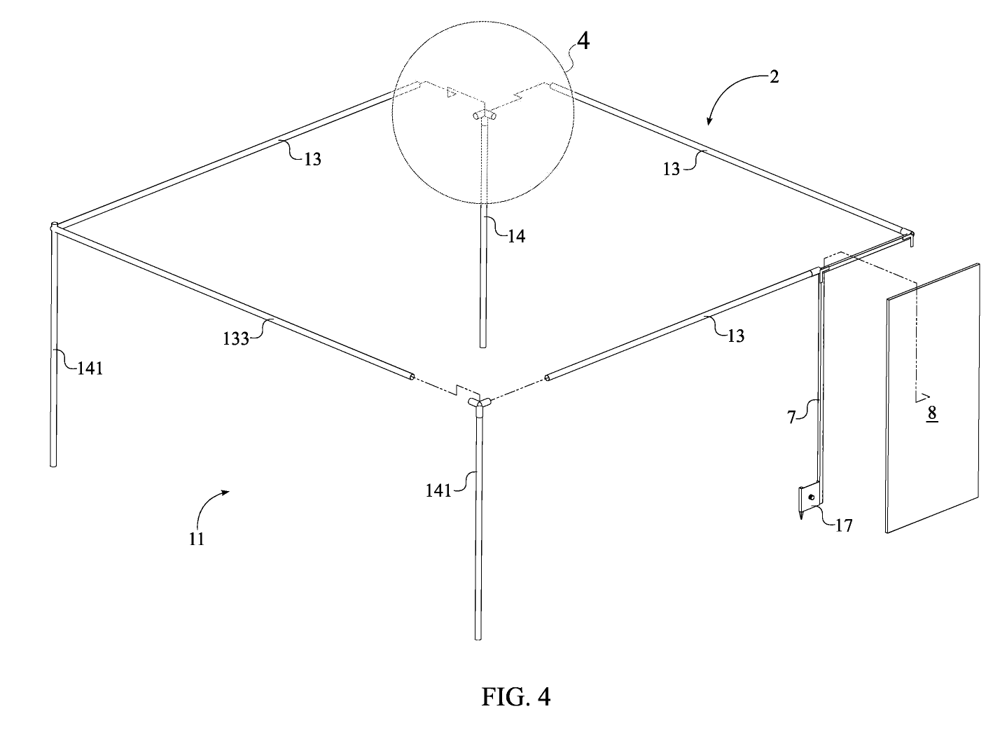

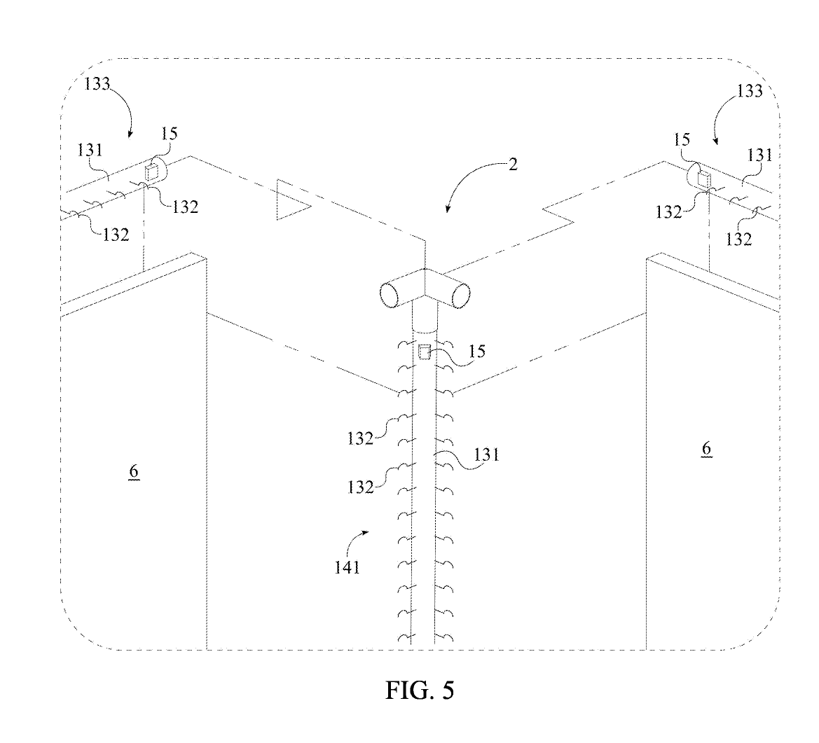

Referring to FIG. 4 and FIG. 5, in the preferred embodiment of the present invention, the main structure 1 comprises a plurality of crossbeams 13, a plurality of corner columns 14, and a plurality of electrical outlets 15. As the name implies, each of the plurality of corner columns 14 forms a corner of the main structure 1. Similarly, each of the plurality of crossbeams 13 forms a top edge of the main structure 1. The plurality of electrical outlets 15 supplies electrical power to the environmental control system 4. Each electrical outlet 15 is terminally mounted onto a corresponding crossbeam from the plurality of crossbeams 13. Preferably, each electrical outlet 15 is terminally mounted onto a corresponding crossbeam from the plurality of crossbeams 13.

In the preferred embodiment, the plurality of crossbeams 13 and the plurality of corner columns 14 are assembled into the space frame. As such, each corner column 141 is terminally and perpendicularly connected between two adjacent crossbeams 131 from the plurality of crossbeams 13. In the preferred embodiment, each corner column 141 connects between two adjacent crossbeams 131 via a corner piece. This allows the user to quickly assemble or disassemble the main structure 1. This is particularly useful for transporting the main structure 1, as the main structure 1 is easily disassembled and loaded into a compact space. Once at the desired location, the main structure 1 can be easily reassembled. Further, the main structure 1 can be assembled into any shape or size by simply increasing the number and rearranging the plurality of crossbeams 13 and the plurality of corner columns 14. Regardless of the overall shape of the main structure 1, each lateral side 11 of the main structure 1 is delineated by an arbitrary two corner columns 141 from the plurality of corner columns 14 and at least one cross beam 131 from the plurality of crossbeams 13. This gives the lateral side 11 a generally rectangular shape which is easily covered by the protective sheet of netting 6.

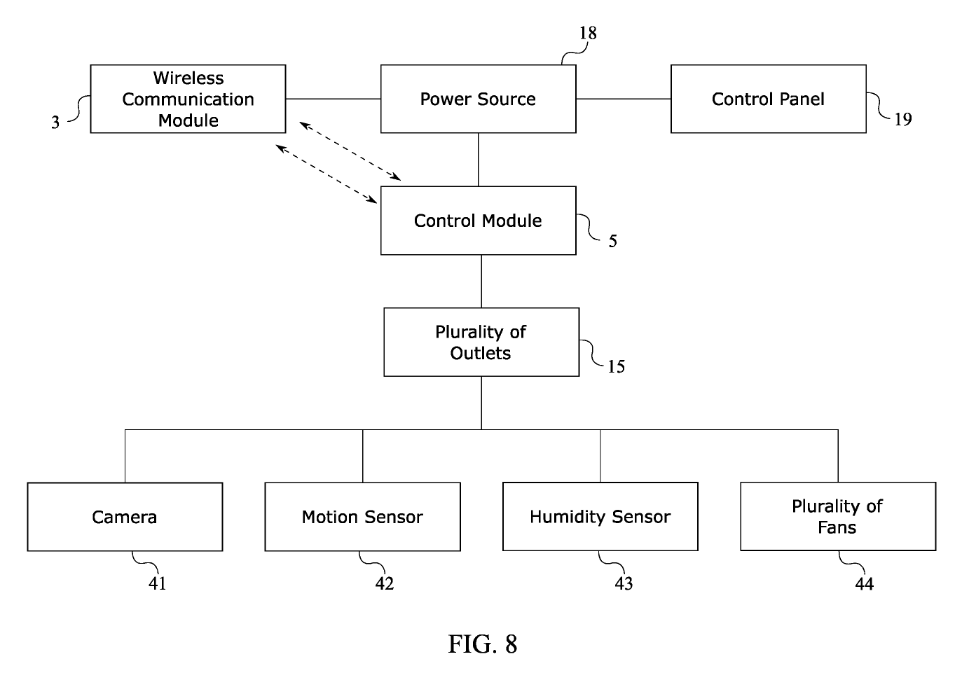

Referring to FIG. 8, further, each electrical outlet 13 is electrically connected to the control module 5. This allows the control module 5 to distribute power to the plurality of electrical outlets 15 from a central source. Accordingly, the pump 24, the humidity sensor 43, the camera 41, the motion sensor 42, and the plurality of fans 44 are each electrically connected to a corresponding outlet from the plurality of outlets 13.

Referring back to FIG. 2, to provide air circulation through the main structure 1, each of the plurality of fans 44 is mounted onto a corresponding corner column from the plurality of corner columns 14. In the preferred embodiment, each fan is mounted to the corresponding corner column via a fan bracket. Further, each fan 44 is positioned opposite another. This generates an airflow through the main structure 1 which removes the carbon dioxide generated by the plants, thereby aiding in plant growth and overall health.

Referring to FIG. 5, in the preferred embodiment, the plurality of crossbeams 13 and the plurality of corner columns 14 each comprises a tubular member 131 and a plurality of hooks 132. The tubular member 131 may have a circular or rectangular cross-section, depending on the strength and weight required. The plurality of hooks 132 attach onto the protective sheet of netting 6. As such, the plurality of hooks 132 is connected adjacent to the tubular member 131. Further, the plurality of hooks 132 is distributed along the length of the tubular member 131. The protective sheet of netting 6 is attached to the tubular member 131 via the plurality of hooks 132. Preferably, each side of the protective sheet of netting 6 is attached to the plurality of hooks 132. This allows the protective sheet of netting 6 to be mounted onto the main structure 1 at the time of assembly. Likewise, this also allows the main structure 1 to be quickly assembled at the desired location.

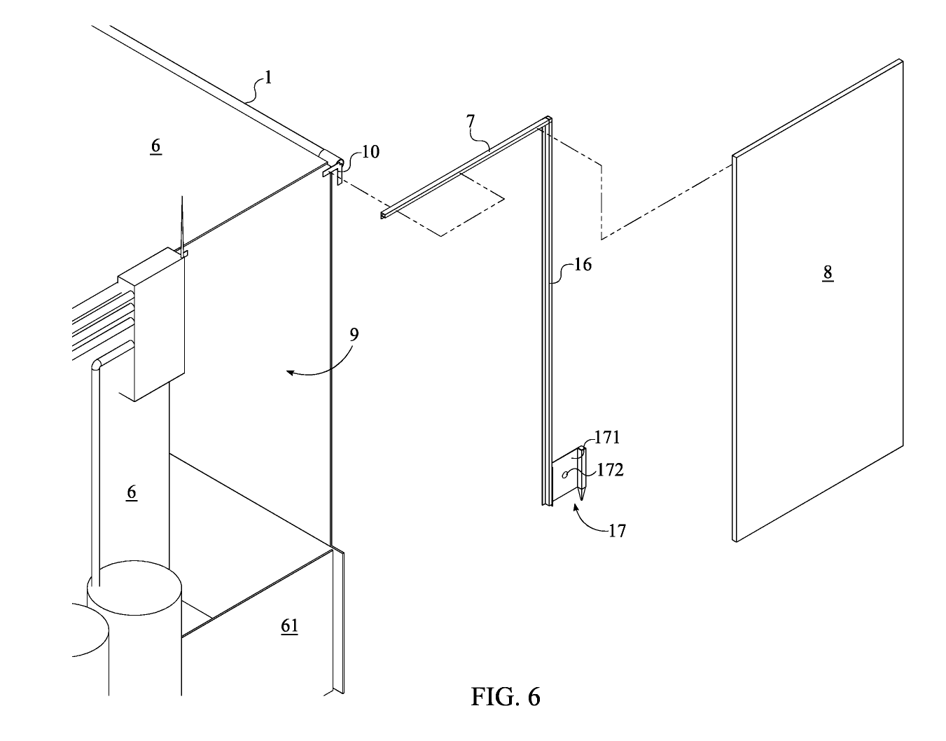

Referring to FIG. 6, an entrance aperture 9 of the present invention allows the user to enter and exit the main structure 1. The entrance aperture 9 is an opening made into the protective sheet of netting 6. As such, the entrance aperture 9 traverses through the protective sheet of netting 6. Further, the entrance aperture 9 is positioned adjacent to an arbitrary lateral side 11 of the main structure 1. Preferably, the entrance aperture 9 may be positioned on any of the side of the main structure 1 thus allowing entrance into the main structure 1 from any side. Accordingly, a door 8 and a door frame 7 of the present invention are provided to close the entrance aperture 9 when necessary. The door 8 and the door frame 7 are attached to the entrance aperture 9 at the time of assembly. Preferably, the door frame 7 is attached to the entrance aperture 9 with a touch-fastening mechanism. As such, a first touch-fastening strip 10 and a second touch-fastening strip 16 are provided within the present invention. In the preferred embodiment, the first touch-fastening strip 10 and the second touch-fastening strip 16 are hook-and-loop fasteners. As such, the first touch-fastening strip 10 is connected along a perimeter of the entrance aperture 9. Similarly, the second touch-fastening strip 16 is connected along a perimeter of the door frame 7. To attach the door frame 7 to the entrance aperture 9, the first touch-fastening strip 10 is attached coincident to the second touch-fastening strip 16, wherein the first touch-fastening strip 10 and the second touch-fastening strip 16 attach the door frame 7 to the entrance aperture 9. Finally, the door 8 is hingedly mounted to the door frame 7.

A watering fixture 17 is used to supply water to the main structure 1. The watering fixture 17 comprises a plate 171 and a connecting adaptor 172. The plate 171 supports the connecting adaptor 172 in the desired position. The connecting adaptor 172 connects a watering line to a hose located inside the main structure 1. As such the connecting adaptor 172 traverses through the plate 171. Preferably, the watering line and the hose are connected at opposite ends of the connecting adaptor 172. In particular, the hose connects to the side of the connecting adaptor 172 located inside the main structure 1. Further, the plate 171 is connected adjacent to the door frame 7.

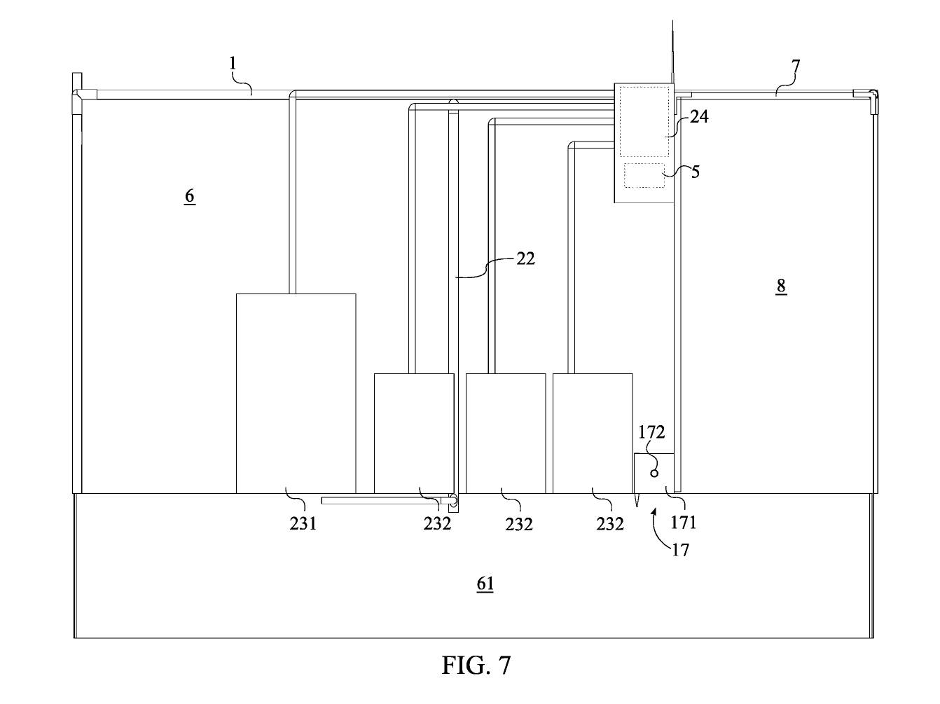

Referring to FIG. 3 and FIG. 7, the preferred embodiment of the plurality of storage tanks 23 comprises a mixture tank 231 and a plurality of nutrient tanks 232. Each of the plurality of nutrient tanks 232 contains a specific nutrient which is pumped into the mixture tank 231. In the preferred embodiment, the plurality of nutrient tanks 232 includes a tank containing liquid phosphorus, a tank containing liquid nitrogen, and a tank containing liquid potassium. The pump 24 circulates the specific nutrient from each nutrient tank and into the mixture tank 231. As such, the plurality of nutrient tanks 232 is in fluid communication with the pump 24. Subsequently, the nutrient mixture in the mixture tank 231 is pumped into the irrigation line 22. As such, the pump 24 is in fluid communication with the mixture tank 231. Further, the mixture tank 231 is in fluid communication with the irrigation line 22. In the preferred embodiment, the nutrient mixture is stored under high pressure to allow the nutrient mixture to travel up the irrigation line 22 and through the tubular sprinkler 21. This is achieved by operating the pump 24 until the pressure inside the mixture tank 231 is up to the desired level. Further, the pump 24 has the ability to selective control the amount of each nutrient used in the nutrient mixture. This is achieved by electronically connecting the pump 24 to the control module 5. In one embodiment, the control module 5 may be pre-programmed with specific nutrients to be used in the nutrient mixture. Alternately, in another embodiment, the user may control the amounts of each nutrient in the nutrient mixture directly through the control module 5. Once the amount of each nutrient is determined, the pump 24 accordingly extracts the appropriate amount of each nutrient from the plurality of nutrient tanks 232.

Referring to FIG. 8, a wireless communication module 3 allows remote access to the control module 5. As such the control module 5 is communicably coupled with the wireless communication module 3. In one embodiment, the wireless communication module 3 allows a mobile phone to connect to the control module 5, whereby the user may remotely operate the control module 5. The wireless communication module 3 uses a wireless local-area-network (WLAN) or cellular network to connect to nearby electronic devices. For example, the wireless communication module 3 may stream video captured by the camera 41 directly to the mobile phone. Further, the wireless communication module 3 may also send warnings and/or notifications when the motion sensor 42 detects anomalous activity around the main structure 1.

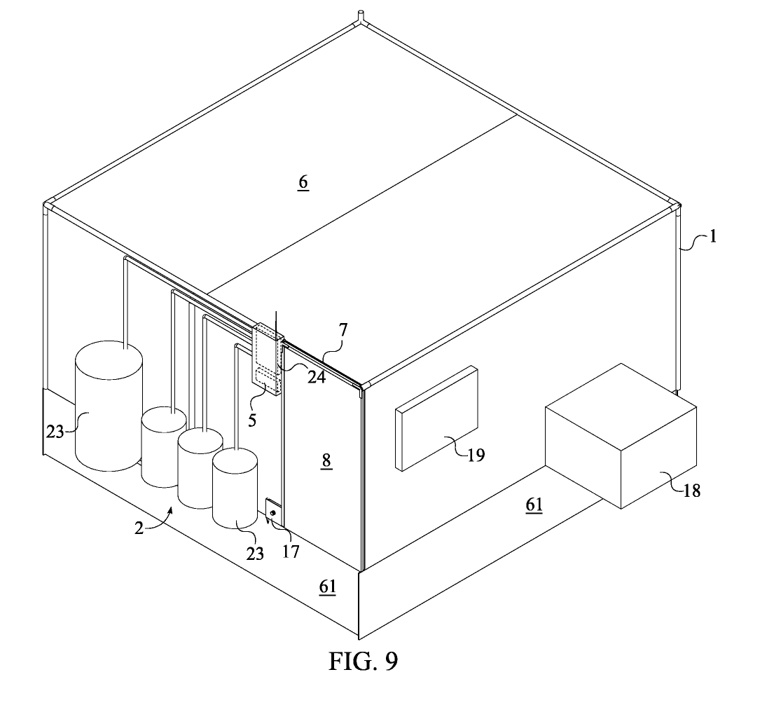

Referring to FIG. 8 and FIG. 9, in the preferred embodiment of the present invention, a power source 18 provides electricity through the plurality of electrical outlets 15. The power source 18 comprises a plurality of rechargeable batteries. The power source 18 is mounted adjacent to the main structure 1. Further, the power source 18 is electrically connected to the control module 5 and the wireless communication module 3. As such, the control module 5 acts as a distribution hub for the electrically operated components. Preferably, the control module 5 distributes electricity from the power source 18 to the plurality of electrical outlets 15. Thus, any electrically device can be hooked into an electrical outlet 15.

In another possible embodiment, the present invention may comprise a control panel 19 and allows the user to interface with the control module 5 from within the main structure 1. As such, the control panel 19 is mounted adjacent to the main structure 1. The preferred control panel 19 comprises a screen with an input/output (I/O) devices such as a keyboard, mouse, touchpad, etc., for interacting with the control module 5. This allows the user to interact with the control module 5 from inside the main structure 1. Finally, the power source is electrically connected to the control module 5 and the control panel 19. This supplies power to the control panel 19 and all of the electrically operated components via the control module 5.

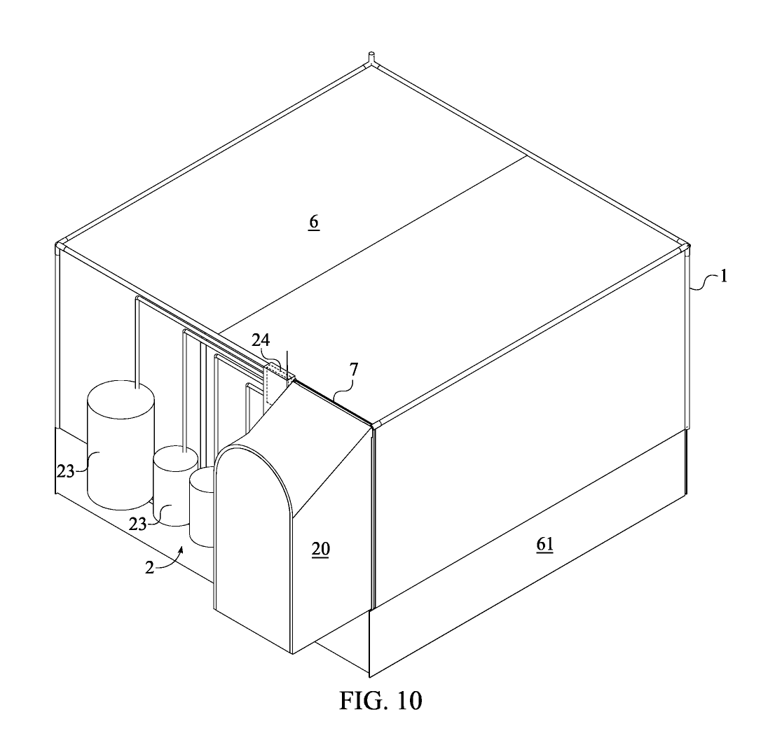

Referring to FIG. 10, a hallway 20 creates a buffer between the inside of the main structure 1 and the outside environment. The user enters the hallway 20 using the hallway entrance, then closes the hallway entrance behind them. Inside the hallway 20, the user can inspect to make sure unwanted animals or insects have not entered. When the hallway 20 is clear, the user can open the door 8 leading into the main structure 1. The perimeter of the hallway entrance is sealed using a canvas and hook and loop attachment. The hook and loop attachment connect the perimeter of the hallway entrance to the netting that forms the cover of the hallway 20.

Although the invention has been explained in relation to its preferred embodiment, it is to be understood that many other possible modifications and variations can be made without departing from the spirit and scope of the invention as hereinafter claimed.

What is claimed is:

1. A greenhouse with integrated irrigation and environmental control systems comprises:
a main structure;
an irrigation system;
an environmental control system;
a control module;
a protective sheet of netting;
the environmental control system comprises a camera, a motion sensor, a humidity sensor, and a plurality of fans;
the irrigation system comprises a tubular sprinkler, an irrigation line, a plurality of storage tanks, and a pump;
the main structure being enclosed by the protective sheet of netting;
the environmental control system being mounted within the main structure;
the tubular sprinkler being positioned across a ceiling of the main structure;
the tubular sprinkler being in fluid communication with the plurality of storage tanks via the irrigation line and the pump;
each of the plurality of fans being connected adjacent to a lateral side of the main structure;
the camera and the motion sensor being mounted adjacent to the ceiling of the main structure; and
the pump, the humidity sensor, the camera, the motion sensor and the plurality of fans being electrically connected to the control module.

2. The greenhouse with integrated irrigation and environmental control systems as claimed in claim 1 comprises:
the protective sheet of netting being attached to each lateral side and the ceiling of the main structure.

3. The greenhouse with integrated irrigation and environmental control systems as claimed in claim 1 comprises:
the main structure comprises a plurality of crossbeams, a plurality of corner columns, and a plurality of electrical outlets;
each electrical outlet being terminally mounted onto a corresponding crossbeam from the plurality of crossbeams;
each corner column being terminally and perpendicularly connected between two adjacent crossbeams from the plurality of crossbeams; and
each lateral side of the main structure being delineated by an arbitrary two corner columns from the plurality of corner columns and at least one cross beam from the plurality of crossbeams; and
each electrical outlet being electrically connected to the control module.

4. The greenhouse with integrated irrigation and environmental control systems as claimed in claim 3 comprises:
the pump, the humidity sensor, the camera, the motion sensor and the plurality of fans each being electrically connected to a corresponding outlet from the plurality of outlets;

5. The greenhouse with integrated irrigation and environmental control systems as claimed in claim 1 comprises:
the main structure comprises a plurality of crossbeams and a plurality of corner columns;
the plurality of crossbeams and the plurality of corner members each comprises a tubular member and a plurality of hooks;
the plurality of hooks being connected adjacent to the tubular member;
the plurality of hooks being distributed along the length of the tubular member; and
the protective sheet of netting being attached to the tubular member via the plurality of hooks.

6. The greenhouse with integrated irrigation and environmental control systems as claimed in claim 1 comprises:
a door frame;
a door;
an entrance aperture;
a first touch-fastening strip;
a second touch-fastening strip;
the entrance aperture traversing through the protective sheet of netting;
the entrance aperture being positioned adjacent to an arbitrary lateral side of the main structure;
the first touch-fastening strip being connected along a perimeter of the entrance aperture;
the second touch-fastening strip being connected along a perimeter of the door frame;
the first touch-fastening strip being attached coincident to the second touch-fastening strip, wherein the first touch-fastening strip and the second touch-fastening strip attach the door frame to the entrance aperture; and
the door being hingedly mounted to the door frame.

7. The greenhouse with integrated irrigation and environmental control systems as claimed in claim 1 comprises:
a watering fixture;
a door frame;
the watering fixture comprises a plate and a connecting adaptor;
the connecting adaptor traversing through the plate; and
the plate being connected adjacent to the door frame.

8. The greenhouse with integrated irrigation and environmental control systems as claimed in claim 1 comprises:
the plurality of storage tanks comprises a mixture tank and a plurality of nutrient tanks;
the plurality of nutrient tanks being in fluid communication with the pump;
the pump being in fluid communication with the mixture tank;
the mixture tank being in fluid communication with the irrigation line; and
the irrigation line being in fluid communication with the tubular sprinkler.

9. The greenhouse with integrated irrigation and environmental control systems as claimed in claim 1 comprises:
a wireless communication module; and
the control module being communicably coupled with the wireless communication module.

10. The greenhouse with integrated irrigation and environmental control systems as claimed in claim 1 comprises:
a power source;
a wireless communication module;
the power source being mounted adjacent to the main structure; and
the power source being electrically connected to the control module and the wireless communication module.

11. The greenhouse with integrated irrigation and environmental control systems as claimed in claim 1 comprises:
a power source;
a control panel;
the power source being mounted adjacent to the main structure;
the control panel mounted adjacent to the main structure; and
the power source being electrically connected to the control module and the control panel.
